(19) United States
(12) Patent Application Publication
(10) Pub. No.: US 2012/0087689 A1
(43) Pub. Date: Apr. 12, 2012

(54) FIXING DEVICE AND IMAGE FORMING APPARATUS PROVIDED THEREWITH

(76) Inventor: Taizou Oonishi, Tokyo (JP)

(21) Appl. No.: 13/269,185

(22) Filed: Oct. 7, 2011

(30) Foreign Application Priority Data
Oct. 12, 2010 (JP) JP2010-229378

(51) Int. Cl. G03G 15/20

(52) U.S. Cl. 399/69; 399/329

(57) ABSTRACT

A fixing device includes: a heating section which heats a recording material; an induction heating heater which heats the heating section by an electromagnetic induction action; a pressing section facing the heating section, which presses the recording material against the heating section; an auxiliary heating member in contact with heating section, provided downstream of the induction heating heater, and upstream of a nip area fanned between heating section and the pressing section, which heats the heating section; an auxiliary heating member temperature sensor which measures a temperature of the auxiliary heating member; and a heating section temperature sensor provided downstream of the induction heating heater and upstream of the auxiliary heating member, which measures a temperature of the heating section.

This application is based on Japanese Patent Application No. 2010-229378 filed on Oct. 12, 2010, which is incorporated hereinto by reference.

### BACKGROUND OF THE INVENTION

The present invention relates to a fixing device and an image forming apparatus including the same.

The IH (Induction Heating) heater using magnetic induction have generally been known to be characterized by higher efficiency in heating a material to be heated with respect to input power, capability of direct and local heating of the material to be heated, and reduction in efficiency if the material to be heated has a higher temperature.

Referring to FIG. 5, the following describes a conventional fixing device that uses an IH heater characterized by higher efficiency in heating a material to be heated with respect to input power, and reduction in efficiency if the material to be heated has a higher temperature.

The conventional fixing device 4′ includes a heating belt 51, an IH heater 52 for heating the heating belt 51 by magnetic induction, an auxiliary heating roller 55 for heating the heating belt 51, and a heating belt temperature sensor 59 for measuring the surface temperature of the heating belt 51.

Even if there is a shortage of electricity used for fixing operation due to some circumstances of a destination in which an image forming apparatus is installed, the heat required for fixing can be supplied by the auxiliary heating roller 55 located on the upstream side of the heater 52, without having to replace the IH heater 52 with a smaller one.

To put it more specifically, to make up for the lack of heat resulting from power shortage in the IH heater 52, the heat generated by the auxiliary heater 551 built in the auxiliary heating roller 55 is adjusted in advance in response to the temperature measured by a heating belt temperature sensor 59, and the shortage of heat generated by the heating belt 51 is covered by the auxiliary heating roller 55 (refer to Japanese Patent Application Publication No. 2009-139674).

In the fixing device disclosed in the Japanese Patent Application Publication No. 2009-139674, a toner image is fixed in a nip region N, which lowers the temperature of the heating belt 51. This arrangement allows the reduced temperature of the heating belt 51 to be increased by the auxiliary, heating roller 55, but the heating belt 51 reaches a high temperature on the upstream side of the IH heater 52, because the auxiliary heating roller 55 is located downstream of the nip region N and upstream of the IH heater 52.

However, the temperature of the heating belt 51 at this time is not sufficient to start fixing operation. The temperature must be increased by the IH heater 52 to the level sufficient for fixing.

However, when a material to be heated has a high temperature, the aforementioned efficiency is reduced by the very nature of the IH heater. Because of this IH heater characteristics, there is a reduction in the efficiency for re-increasing the temperature of the heating belt 51 which has already been increased to a high temperature by the auxiliary heating roller 55. This arrangement fails to make the maximum use of the high efficiency of the IH heater, with the result that power consumption is increased.

Further, in the belt type fixing device, if a great number of small-sized sheets are subjected to the fixing operation, the temperature of the sheet conveying portion of the fixing belt is reduced because the heat is carried off to the sheets, whereas the temperature outside the sheet conveying portion is increased because the heat is not earned off to the sheets, with the result that the temperature in the axial direction of the fixing belt becomes uneven, as is commonly known.

If uniformity of the temperature of the fixing belt in the axial direction has been lost, when large-sized sheets are subjected to the process of fixing in the next step, there will be a difference in glossiness on the boundary between the sheet conveying portion of the small-sized sheet processed before the large-sized sheet, and the outer side of the sheet conveying portion. This is known to be identified as a fixing quality error (e.g., glossiness non-uniformity).

The fixing device described in the Japanese Patent Application Publication No. 2009-139674 has failed to provide means to protect against lack of uniformity in the temperature of the fixing belt in the axial direction, This may lead to a fixing quality error (e.g., glossiness non-uniformity).

### SUMMARY OF THE INVENTION

In view of the problems described above, it is an object of the present invention to provide a fixing device and an image forming apparatus including the same, wherein the fixing device is characterized by a high degree of fixing quality capability of making the maximum use of the high-efficiency characteristics of an IH heater, and minimized power consumption.

1. To achieve at least one of the abovementioned objects, a fixing device reflecting one aspect of the present invention, has: a heating section for heating a recording material; an IH heater (induction heating heater) for heating this heating section through magnetic induction; a pressing section opposed to the heating section to press the recording material against the heating section; an auxiliary heating member in contact with the heating section, the aforementioned auxiliary heating member being arranged downstream of the IH heater and upstream of the nip section composed of the heating section and pressing section to heat the heating section; an auxiliary heating member temperature sensor for measuring the temperature of the auxiliary heating member; and a heating section temperature sensor arranged downstream of the IH heater and upstream of the auxiliary heating member to measure the temperature of the heating section.

2. In the fixing device described in item I above, the heating section temperature sensor preferably includes: a heating section central sensor for measuring the temperature on the central section side perpendicular to the recording material conveying direction in the heating section; and a heating section edge sensor located inside the edge of the passing region of the maximum usable size of the recording material to measure the temperature of the edge side in the aforementioned perpendicular direction in the heating section.

3. In the fixing device described in item 2 above, the heating section preferably includes a belt-shaped heating belt for heating a recording material; a backup roller located opposed to the IH heater through the heating belt to wind the heating belt on the one hand; and a nip roller on the heating side to wind the heating belt on the other hand; the aforementioned fixing device preferably includes a step of the IH heater heating the heating belt; a step of the auxiliary heating member heating the heating belt; and a step of the heating section central sensor and heating section edge sensor measuring the surface temperature of the heating belt; and the pressing section preferably includes a nip miler on the pressure side to press the recording material against the nip roller on the heating side.

4. In the fixing device described in item 2 above, the heating section preferably includes a heating roller for heating a recording material; the aing device preferably includes: a step of the IH heater heating the heating roller; a step of the auxiliary heating member heating the heating roller; a step of the heating section central sensor and heating section edge sensor measuring the surface temperature of the heating roller; and the pressing section preferably includes a nip roller on the pressure side to press the recording material against the heaping roller.

5. An image forming apparatus including: an image forming section for forming a toner image; and the fixing device described in any one of the items 1 through 4 for fixing the toner image on a recording material.

6. In the image forming apparatus described in item 5 above, the heating section temperature sensor preferably includes: a heating section central sensor for measuring the temperature on the central section side perpendicular to the recording material conveying direction in the heating section; and a heating section edge sensor located inside the edge of the recording material passing region of the maximum-sized usable sheet to measure the temperature of the edge side in the aforementioned perpendicular direction in the heating section; and the image forming apparatus preferably includes a controller capable of controlling the heat generated by the auxiliary heating member in such a way that a value between the higher and lower measurements in the measurement of the heating section central sensor and the measurement of the heating section edge sensor is set to the targeted temperature for heating the heating roller, and agreement will be reached between the targeted temperature and the measurement of the auxiliary heating member temperature sensor.

### BRIEF DESCRIPTION OF THE DRAWINGS

FIG. 1 is an explanatory diagram representing an image forming apparatus;

FIG. 2 is an explanatory diagram (side view) representing the first embodiment of a fixing device;

FIG. 3 is a diagram representing the relationship among a heating belt, auxiliary heating roller, auxiliary roller temperature sensor, heating belt temperature sensor and sheet in the orthogonal direction X;

FIG. 4 is an explanatory diagram (side view) showing the second embodiment of a fixing device; and

FIG. 5 is an explanatory diagram showing a conventional fixing device.

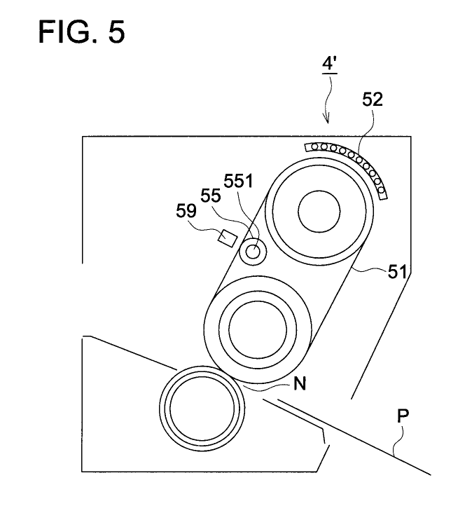

### DETAILED DESCRIPTION OF THE PREFERRED EMBODIMENT

The following describes the wording used in the description of each structure.

The upstream side of the fixing device is defined as the side from which a given point of the heating belt or heating roller moves, while the downstream side of the fixing device is defined as the side to which a given point of the heating belt or heating roller moves.

The direction parallel to the sheet conveying direction is defined as the parallel direction Y. In the nip region, the direction perpendicular to the extension of the surface wherein the recording material is conveyed is called the perpendicular (orthogonal) direction X.

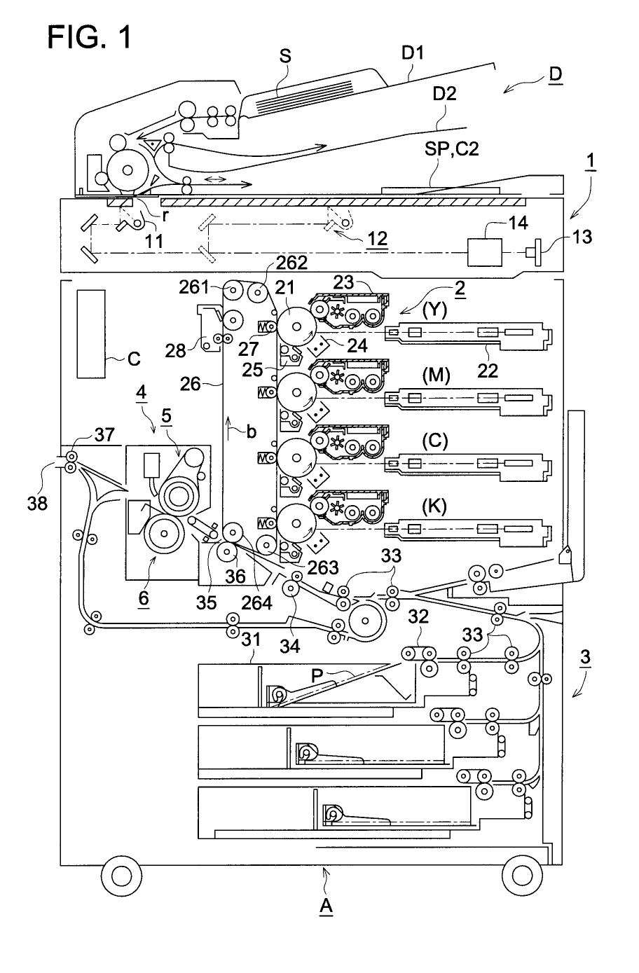

FIG. 1 is an explanatory diagram representing an image forming apparatus.

The following describes the image forming apparatus A called the tandem type full-color copying machine as an example of the image forming apparatus.

The automatic document feeder D picks up each of the documents S loaded on the sheet feed tray D1. The document is then conveyed to the region r wherein the image information is read from the document S in the document reading region r. This document S is then ejected to the sheet ejection tray D2.

The document image reading section 1 includes a light source 11, a movable scanning unit 12 and an optical. system 14 for forming a document image on the line image sensor 13.

For example, in the stationary type optical reading operation, the scanning unit 12 is fixed to the document reading region r to read the image of the document S conveyed by the automatic document feeder D. In traveling type optical reading operation, the scanning unit 12 is moved to read the image of the document placed on the document image reading section 1.

The analog signal of the document image subjected to photoelectric conversion by the line image sensor 13 undergoes analog processing, analog-to-digital conversion, shading correction, image compression and other processing in an image processing section (not illustrated), whereby digital image data of yellow (Y), magenta (M), cyan (C) and black (K) are obtained.

The area around the drum-like photoreceptors 21 (21Y, 21M, 21C and 21K) as first image carriers is provided with the exposure sections 22 (22Y, 22M, 22C and 22K) for forming latent images based on the digital image data of each color, development sections 23 (23Y, 23M, 23C and 23K)) for developing latent images of corresponding colors by toner, charging sections 24 (24Y, 24M, 24C and 24K) for uniformly charging the photoreceptors 21, and cleaning sections 25 (25Y, 25M, 25C and 25K) for removing the toner remaining on the surfaces of the photoreceptors 21 without being transferred onto the intermediate transfer member 26.

Here, the photoreceptor 21, exposure section 22 and development section 23 constitute the image forming section 2 that forms a toner image.

Further, a semiconducting endless belt-shaped intermediate transfer member 26 rotatably trained about rollers 261, 262, 263 and 264 is arranged opposed to each of the photoreceptors 21 (21Y, 21M, 21C and 21K). The intermediate transfer member 26 is driven in the direction of arrow b by a driving device (not illustrated) through a roller 263.

The toner image of each color carried by photoreceptors 21 is sequentially transferred onto the intermediate transfer member 26 by the pressures of the primary transfer rollers 27 (27Y, 27M, 27C and 27K), and a superimposed color image is formed.

The cleaning section 28 removes the toner remaining on the intermediate transfer member 26 without being transferred onto the recording material.

The sheet feeding section 3 includes a plurality of sheet feed cassettes 31 as sheet accommodation members. The recording material is accommodated in the sheet feed cassette 31.

The recording material includes a resin sheet and sheet-like paper, and will be referred to as “sheet P” in the following description.

Each of the accommodated sheets P is picked up by the sheet feed roller 32, and is fed to the transfer region 35 through a plurality of conveying roller 33 and registration roller 34. The toner images superimposed on the intermediate transfer member are collectively transferred on the sheet P conveyed under the pressure of the secondary transfer roller 36.

The sheet P with the toner image transferred thereon is subjected to curvature-separation by the intermediate transfer member 26, and the toner image is fixed onto the sheet P by the fixing device 4.

The sheet P with the toner image fixed thereon is interposed by the ejection roller 37, and is ejected out of the apparatus.

The aforementioned operations are controlled by the controller C in charge of overall control of the image forming apparatus.

The tandem type full-color copying machine has been described with reference to an example. It goes without saying that the fixing device 4 is applicable to the monochromatic copying machine.

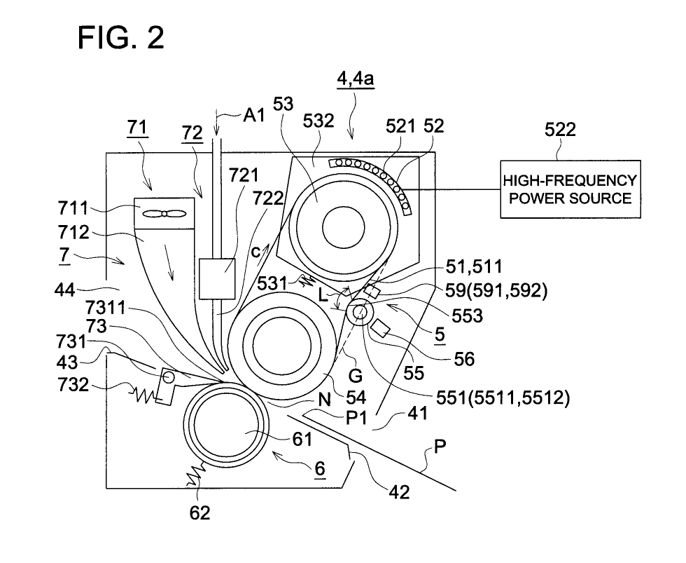

FIG. 2 is an explanatory diagram (side view) representing the first embodiment of a fixing device.

In FIG. 2, when an image is formed on one side of the sheet P, a toner image is formed on the illustrated upper surface of the sheet Pin the previous process shown on the right of FIG. 2. When an image is formed on both sides, the updated toner image is formed on the illustrated upper surface of the sheet P.

The fixing device 4a as a first embodiment of the fixing device 4 includes a heating section 5 for heating the sheet P, and a pressing section 6 for pressing the sheet P against the heating section 5.

The heating section 5 is provided with: a belt-shaped heating belt 51 for heating the sheet P; an IH heater 52 for heating the heating belt 51 by magnetic induction; a backup roller 53 opposed to the IH heater 52 to wind the heating belt 51 on the one hand; a nip roller 54 on the heating side to wind the heating belt 51 on the other hand; an auxiliary heating roller 55 which is arranged in contact with the heating belt 51 and downstream of the IH heater 52 and upstream of the nip roller 54 on the heating side for the purpose of heating the heating belt 51; and a heating belt temperature sensor 59 for measuring the surface temperature of the heating belt 51. The pressing section 6 is provided with the nip roller 61 for forming a nip region Non the pressure side, opposed to the nip roller 54 on the heating side,

The unfixed sheet P conveyed to the inlet 41 of the fixing device 4a is guided to the inlet guide plate 42 to reach the nip region. N. In the nip region N, the sheet P is heated and pressed by the heating section 5 and pressing section 6 so that the toner image is fixed onto the sheet P. Then the sheet P with the toner image fixed thereon is ejected out of the ejection outlet 44, led by the ejection guide plate 43.

The following describes the details of the component members.

The heating belt 51 is a ring-shaped thin belt. The basic material is a thin magnetic metal plate (e.g., 30- through 50-μm thick nickel, iron). The thin magnetic metal plate has a surface thickness of 50 through 300 μm and is covered with a silicon rubber having a JIS-A hardness of 5 through 40. The silicon rubber surface is coated with PFA (tetrafluomethylene-perfluoroalkyl vinyl ether copolymer), PTFE (polytetrafluoroethylene (tetrafluoride) or the mixed material thereof. The magnetic metal layer 511 as a thin magnetic metal plate generates heat through the IH heater 52.

The heating belt 51 is driven in the direction of arrow c by the backup roller 53, nip roller 54 on the heating side and a driving section (not illustrated) that drives one or both of the backup roller 53 and nip roller 54.

The IH heater 52 is arranged opposed to the backup roller 53 at a prescribed interval. The built-in IH coil 521 is connected to the high-frequency power source 522 that produces high-frequency power (e.g., 20 through 40 kHz).

The IH coil 521 generates high-frequency magnetic lines of force when high-frequency power is applied to the IH coil 521. When the magnetic line of force has penetrated the magnetic metal layer 511 of the heating belt 51, eddy current I occurs to the magnetic metal layer 511. Joule heat represented by the expression W=I×R is produced inside the heating belt 51 (magnetic metal layer 511) by the produced eddy current I and electric resistance R of the magnetic metal layer 511.

The backup roller 53 is a roller having a diameter of 30 through 50 mm. The basic material is a non-magnetic metal (e.g., aluminum, SUS), and is coated with a heat-resistant non-magnetic resin material (for example, silicon rubber, polyimide, PEEK (polyether ether ketone)).

The IH heater 52 and backup roller 53 are located on the movable supporting member 532. A supporting member 532 with the IH heater 52 and backup roller 53 mounted thereon arc biased toward the side opposite the nip roller 54 on the heating side by an elastic member 531 (e.g., compression spring).

Since the IH heater 52 and backup roller 53 are mounted on the supporting member 532, the distance between the IH heater 52 and backup roller 53, namely, the gap between the IH heater 52 and heating belt 51 is kept constant, even if the supporting member 532 has been displaced. Thus, the amount of heat generated by the heating belt 51 with respect to the output of the IH heater 52 is kept constant.

The nip roller 54 on the heating side has a diameter of 50 to 70 mm. The cored bar made of metal (e.g., aluminum, ion, SUS) is coated with an elastic body (e.g., silicon rubber having a thickness of 2 to 15 mm with a JIS-A hardness of 5 to 40)). This is further coated with a mold release layer (e.g., PFA, PTEE, mixed material thereof).

The auxiliary heating roller 55 as an auxiliary heating member for heating the heating belt 51 is a cylindrical roller having a diameter of 16 to 25 mm. The auxiliary heating roller 55 has a built-in auxiliary heater 551, and assists reheating of the heating belt 51 heated by the IH heater 52 located upstream.

The auxiliary heating roller 55 is made of a cylindrical cored bar of a metal (e.g., aluminum) characterized by a high degree of heat transfer capacity This cored bar is coated with a mold release layer (e.g., PFA, PTEE, mixed material thereof).

The auxiliary heating roller 55 is composed of a cored bar made of a metal characterized by a high degree of heat transfer capacity This structure facilitates transfer of heat in the orthogonal direction X of the auxiliary heating roller 55, which, in turn, ensures uniform temperature in the orthogonal direction X.

When brought in contact with the heating belt 51 wherein the temperature in the orthogonal direction Xis not uniform, heat is exchanged between the auxiliary heating roller 55 wherein the temperature in the orthogonal direction X is uniform, and the heating belt 51 wherein the temperature in the orthogonal direction Xis not uniform, with the result that the temperature in the orthogonal direction X of the heating belt 51 becomes uniform.

In the following description, the temperature of the heating belt 51, auxiliary heating roller 55 and others in the orthogonal direction X (in the direction of width and axis) is also called the temperature distribution.

As described above, the auxiliary heating roller 55 has a function of assisting the heating by the heating belt 51 and a function of keeping uniform the temperature of heating belt 51 in the orthogonal direction X.

A halogen lamp is preferably utilized as the auxiliary heater 551 built in the auxiliary heating roller 55. The halogen lamp heats the auxiliary heating roller 55.

The auxiliary heating roller 55 is provided outside the ring-shaped heating belt 51. To ensure that the length L of the contact surface 553 produced by contact between the auxiliary heating roller 55 and heating belt 51 will be increased, the contact surface 553 will be located inside (left in the drawing) the common tangential G (broken line) between the backup roller 53 and nip roller 54 on the heating side.

The auxiliary heating roller 55 is only required to transfer heat to the heating belt 51 for a long time. The auxiliary heating roller 55 can be arranged inside the heating belt 51 so that the contact surface 553 will be located outside the common tangential G (broken line).

The auxiliary roller temperature sensor 56 is a non-contact type temperature sensor for measuring the surface temperature of the auxiliary heating roller 55. A thermister or a thermopile where a plurality of small-sized thermocouples are connected is preferably utilized.

The heating belt temperature sensor 59 as a heating section temperature sensor is arranged downstream of the IH heater 52 and upstream of the auxiliary heating roller 55. The heating belt temperature sensor 59 is used to measure the temperature of the heating belt 51.

The heating belt temperature sensor 59 includes: a heating section central sensor 591 for measuring the surface temperature of the central section perpendicular to th.e sheet conveying direction in the heating belt 51, namely, the surface temperature on the central section across the width of the heating belt 51; and a heating section edge sensor 592 located inside the passing region of the maximum usable size of the edge of the recording material sheet to measure the temperature on the edge side in the perpendicular direction in the heating belt 51, namely, the temperature on the edge side across the width of the heating belt 51.

The heating section central sensor 591 and heating section edge sensor 592 are non-contact type temperature sensors. A thermister or a thermopile where a plurality of small-sized thermocouples are connected is preferably utilized. The controller C calculates the targeted temperature T for heating the auxiliary heating roller 55, based on the measurements of the heating section central sensor 591 and heating section edge sensor 592.

The nip roller 61 on the pressure side is a roller having a diameter of 50 to 70 mm. The nip roller 61 is composed of the cored bar formed of a metal such as aluminum, ion or SUS, which is coated with an elastic body (e.g., silicon rubber having a thickness of 0.5 to 5 mm with a JIS-A hardness of 5 through 40). This is further coated with a mold release layer (e.g., PFA, PTEE, mixed material thereof).

The sheet P is pressed against the heating belt 51 wound on the nip roller 54 on the heating side at a force of 500 to 1500 N by the elastic member (e.g., compaction spring) 62 for biasing the nip roller 61 on the pressure side toward the nip roller 54 on the heating side.

A means for driving the heating belt 51 has been described with reference to the structure provided with a driving section (not illustrated) that drives one or both of the backup roller 53 and nip roller 54. It is also possible to arrange such a configuration that the auxiliary heating roller 55 is provided with a one-way clutch (not illustrated) and a motor (not illustrated) for driving the one-way clutch, and that the auxiliary heating roller 55 is driven by this motor through the one-way clutch.

The one-way clutch has the following functions: normally, heating belt 51 is driven by above-mentioned driving section through the backup roller 53, the auxiliary heating roller 55 is also driven resultantly. When the driving section is put into trouble, the heating belt 51 is driven by the motor through the auxiliary heating roller 55. This avoids excessive heating of the heating belt 51 caused by suspension of the heating belt 51.

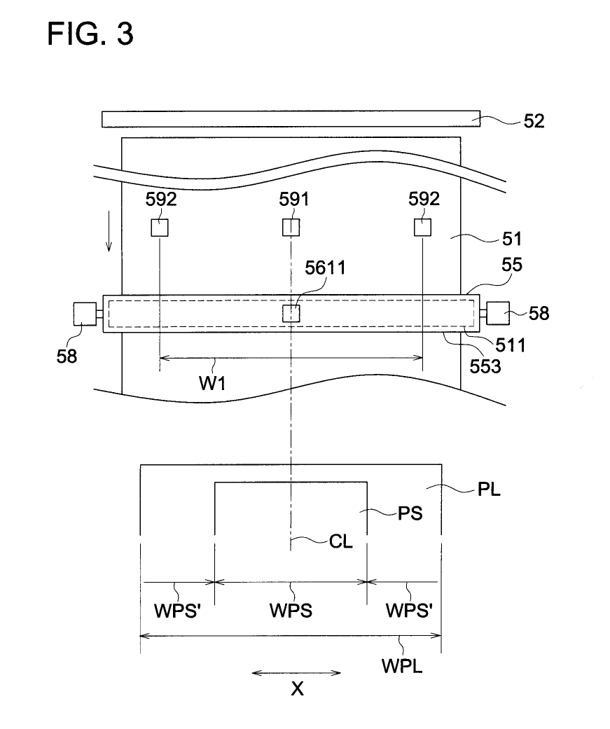

Referring to FIG. 3, the following describes how to maintain uniform temperature in the orthogonal direction X of the heating belt 51 by the auxiliary heating roller 55.

FIG. 3 is a diagram representing the relationship among a heating belt, auxiliary heating roller, auxiliary roller temperature sensor, heating belt temperature sensor and sheet in the orthogonal direction X.

FIG. 3 shows the vicinity of the auxiliary heating roller 55 of FIG. 2 as viewed from the side (right in FIG. 2). For ease of explanation, a pair of heating section edge sensors 592 is assumed to be arranged in a bilaterally bilateral symmetry about the reference position CL for sheet conveyance.

The sheet having a width smaller than the distance wl for installing a pair of heating section edge sensors 592 in the orthogonal direction Xis called a small-sized sheet PS. The sheet having a width greater than the distance w1 for installing a pair of heating section edge sensors 592 is called a large-sized sheet PL.

First, the following describes the exchange of heat between the heating belt 51 and auxiliary heating roller 55 on the contact surface 553 wherein the heating belt 51 is brought in contact with the auxiliary heating roller 55.

As the temperature of the auxiliary heating roller 55 is higher than the temperature of the heating belt 51, a greater amount of heat is supplied to the heating belt 51 and the temperature of the heating belt 51 is increased. As the temperature of the auxiliary heating roller 55 is lower than the temperature of the heating belt 51, a greater amount of heat is absorbed from the heating belt 51 and the temperature of the heating belt 51 is decreased.

Accordingly, when the temperature of the heating belt 51 in a orthogonal direction X is not uniform, the temperature of the auxiliary healing roller 55 is set at a level between the higher and lower temperatures of the auxiliary heating roller 55. This allows the low-temperature portion of the heating belt 51 to be heated by the auxiliary heating roller 55. The high-temperature portion of the heating belt 51 is absorbed by the auxiliary heating roller 55. This arrangement ensures a uniform temperature of the heating belt 51.

In the present invention, the targeted temperature T for heating the auxiliary heating roller 55 is calculated based on the measurements of the heating section central sensor 591 and heating section edge sensor 592. The amount of heat generated by the auxiliary heater 551 is controlled to ensure that the temperature of the auxiliary heating roller 55 will reach the targeted temperature T having been calculated.

Of the temperatures measured by the heating section central sensor 591 and heating section edge sensor 592, the temperature (e.g., 200° C.) between the higher temperature (e.g., 220° C.) and lower temperature (e.g., 180° C.) is set as the targeted temperature T. To ensure that the preset targeted temperature T will be reached, the auxiliary heater 551 is turned off or the input power is reduced if the measurement of the auxiliary roller temperature sensor 56 is higher than the targeted temperature T.

The auxiliary heater 551 is turned on or the input power is increased if the measurement of the auxiliary roller temperature sensor 56 is lower than the targeted temperature T.

This procedure allows the heat to be exchanged between the heating belt 51 and auxiliary heating roller 55 when the heating belt 51 has contacted the auxiliary heating roller 55 whose temperature lies between the temperatures at the high-temperature portion and the low-temperature portion of the heating belt 51. This provides uniform temperature in the orthogonal direction X of the heating belt 51.

For example, when there is continuous conveyance of small-sized sheets PS, the heating belt 51, in the nip region N (not illustrated), there is a gradual decrease in temperature with the heat being carried off to the sheet P in the small-sized passing range wPS wherein small-sized sheets PS pass by. However, there is a gradual increase in temperature without the heat being carried off to the sheet P in the small-sized non-passing range wPS′ wherein no small-sized sheet PS passes by. This produces uneven temperatures in the orthogonal direction X.

In the edges of the nip roller 54 on the heating side (not illustrated) and auxiliary heating roller 55, heat escapes from the support section 58 which rotatably support the roller, thereby reducing the temperature of the edge of the heating belt 51. However, temperature reduction by the support section 58 can be ignored because it is small as compared with the rise in temperature in the small-sized non-passing range wPS′.

The heating belt 51 is heated by the IH heater 52 located upstream of the auxiliary heating roller 55. However, the uneven temperature of the heating belt 51 in the aforementioned orthogonal direction X is not corrected by the IH heater 52 that provides uniform temperature in the orthogonal direction X, so the heating belt 51 travels toward the auxiliary heating roller 55 while maintaining the uneven temperature distribution in the aforementioned orthogonal direction X.

There is a gradual reduction in temperature (e.g., 180° C.) in the portion of the auxiliary heating roller 55 in contact with the small-sized sheet passing range wPS wherein the temperature of the heating belt 51 is reduced, whereas there is a gradual increase in temperature (e.g., 200° C.) in the portion of the auxiliary heating roller 55 in contact with the small-sized non-passing range wPS′ wherein the temperature of the heating belt 51 has risen.

To ensure the uniform temperature in the orthogonal direction X immediately before the nip region N of the heating belt 51, the targeted temperature T for heating the auxiliary heating roller is automatically updated to a level higher the measurement (e.g., 180° C.) by the heating section central sensor 591 and lower than the measurement (e.g., 200° C.) by the heating section edge sensor 592.

To put it more specifically, a step is taken to calculate a temperature (e.g., 185° C.) which is lower than the temperature (e.g., 190° C.) between the measurement (e.g., 180° C.) of the heating section central sensor 591 and the measurement (e.g., 200° C.) of the heating section edge sensor 592, and higher than the measurement (e.g., 180° C.) of the heating section central sensor 591. The targeted temperature T is updated to the calculated value (e.g., 185° C.).

The temperature (e.g., 200° C.) determined as the targeted temperature T is set before the first fixing operation is performed.

The power generation of the auxiliary heater 551 is controlled by the controller C in such a way as to reach a value equal to the updated value (e.g., 185° C.) calculated from the temperature of the measurement of the auxiliary heating roller 55 by the auxiliary roller temperature sensor 56.

This allows the heat of the high-temperature edge of the heating belt 51 to be absorbed by the low-temperature edge of the auxiliary heating roller 55. The low-temperature central section of the heating belt 51 is heated by the high-temperature central section of the auxiliary heating miler 55. This improves the uneven temperature distribution between the small-sized sheet passing range wPS and small-sized non-passing range wPS′ of the heating belt 51. To put it another way, uniform temperature distribution of the heating belt 51 is provided.

If the uniform temperature distribution of the heating belt 51 has been achieved, there will be no differ nice in glossiness on the boundary between the small-sized sheet passing range wPS and small-sized non-passing range wPS′, when an image is fixed on a large-sized sheet or when an image is fixed on a still smaller-sized sheet subsequently. This will provide a high-quality image.

For example, when large-sized sheets PL are conveyed on a continuous basis, in the nip region N (not illustrated), heat of the heating belt 51 is reduced by the sheet Pin the large-sized sheet passing range wPL wherein large-sized sheets PL passes through. This results in a gradual reduction in temperature.

Further, heat of the edge portion 58 of the auxiliary heating roller 55 escapes from the support section 58 for rotatably supporting the roller. The resultant reduction in temperature causes the temperature on the portion outside the large-sized sheet passing range wPL of the heating belt 51 to be reduced below that of the large-sized sheet passing range wPL.

With respect to the reduction in temperature of the large-sized sheet passing range wPL, reduction in temperature outside the large-sized sheet passing range wPL cannot be ignored. This causes uneven temperature in the orthogonal direction X.

The heating belt 51 is heated by the IIT heater 52 located upstream of the auxiliary heating roller 55. The uneven temperature of the heating belt 51 in the orthogonal direction X cannot be corrected by uniform heating in the orthogonal direction X. The heating belt 51 travels toward the auxiliary heating roller 55, while the aforementioned uneven temperature in the orthogonal direction X is kept uncorrected.

There is a trend toward a gradual reduction in temperature (e.g., 180° C.) in the portion of the auxiliary heating roller 55 in contact with the large-sized sheet passing range wPL of the heating belt 51 with reduced temperature. There is a trend toward a gradual further reduction in temperature (e.g., 160° C.) in the portion of the heating belt 51 in contact with the outside of the large-sized sheet passing range wPL of the heating belt 51 with further reduced temperature.

To ensure uniform temperature in the orthogonal direction X immediately before the nip region N of the heating belt 51, the targeted temperature T for heating the auxiliary heating roller is automatically updated to a level lower than the measurement (e.g., 180° C.) of the heating section central sensor 591 and higher than the measurement (e.g., 160° C.) of the heating section edge sensor 592.

To put it more specifically, a step is taken to calculate a value (e.g., 175° C.) which is higher than the temperature (e.g., 170° C.) between the measurement (e.g., 180° C.) of the heating section central sensor 591 and the measurement (e.g., 160° C.) of the heating section edge sensor 592, and which is lower than the measurement (e.g., 180° C.) of the heating section central sensor 591. The targeted temperature is updated to the new value (e.g., 175° C.) having been calculated.

Before the first fixing operation is performed, the temperature (e.g., 200° C.) predetermined as the targeted temperature T is set.

The heat generation of the auxiliary heater 551 is controlled by the controller C in such a way that the temperature measurement of the auxiliary heating roller 55 by the auxiliary roller temperature sensor 56 will be equal to the updated value (e.g., 175° C.) having been calculated.

The heat of the central section of the heating belt 51 having a temperature higher than that of the edge portion is absorbed by the central section of the auxiliary heating roller 55 having a lower temperature. The edge portion of the heating belt 51 having a temperature lower than that of the temperature is heated by the edge portion of the auxiliary heating roller 55 having a higher temperature. This provides uniform temperature distribution between the large-sized sheet passing range wPL and large-sized sheet non-passing range wPL′ of the heating belt 51. That is, this step provides a uniform temperature distribution of the heating belt 51.

If the uniform temperature distribution of the heating belt 51 has been achieved, when an image is fixed on a larger-sized or smaller-sized sheet next time, there will be no difference in glossiness on the boundary between sheet passing range and sheet non-passing range, and a high-quality image can be provided.

A plurality of pairs of or one pair of heating section edge sensors 592, or even only one sensor 592, may be installed.

If a plurality of sensors are provided, it becomes possible to set the targeted temperature T for heating the auxiliary heating roller more accurately in response to the requirements of different sizes. When one sensor is provided, the system structure can be simplified.

As described above, an auxiliary heating roller 55 for heating the heating belt 51, a heating section central sensor 591 for measuring the surface temperature of the central section of the heating belt 51, and a heating section edge sensor 592 for measuring the surface temperature of the edge portion of the heating belt 51 are installed downstream of the lB heater 52 and upstream of the nip region N for performing the fixing operation. The targeted temperature T of the auxiliary heating roller set at a level between the measurement of the heating section central sensor 591 and the measurement of the heating section edge sensor 592. The auxiliary heater 551 is controlled to ensure that the temperature measurement of the auxiliary heating roller 55 by the auxiliary roller temperature sensor 56 will be equal to the targeted temperature T having been set, whereby uneven temperature distribution of the heating belt 51 can be corrected. This provides an image of uniform. fixing quality free from glossiness non-uniformity in the orthogonal direction X.

The above description is based on the assumption that the auxiliary heater 551 is one heater spanning roughly the entire length of the auxiliary heating roller 55. It can be composed of two heaters: a central heater (not illustrated) for heating the central portion of the auxiliary heating roller 55, and an edge heater (not illustrated) for heating the edge portion of the auxiliary heating roller 55.

In this case, the controller C provides control in such a way that, when there is an excessive reduction of temperature at the edge portion of the heating belt 51, for example, the targeted temperature T for heating the edge heater is increased over the current value, while, when there is an excessive rise in the temperature of the central portion of the heating belt 51, the targeted temperature for heating the central heater is reduced below the current value.

As described above, fine adjustment of the temperature of the auxiliary heating roller 55 in the orthogonal direction X is enabled in response to the temperature distribution of the heating belt 51 in the orthogonal direction X, thereby effectively minimizes non-uniformity of the temperature distribution on the heating belt 51 in the orthogonal direction X.

A plurality of (e.g., ten) measurements of the heating section central sensor 591 and heating section edge sensor 592 each are sequentially memorized. Then a step is taken to work out the moving averages of a plurality of these measurements sequentially, and to calculate each of the moving average values of the heating section central sensor 591 and heating section edge sensor 592.

This is followed by the step of working out the temperature between the latest moving average of the heating section central sensor 591 having been calculated, and the latest moving average of the heating section edge sensor 592. The currently used targeted temperature T may be replaced with the calculated temperature as an updated targeted temperature T for heating the auxiliary heating roller.

When the aforementioned moving average is worked. out, stable fixing operation can be ensured by eliminating the possible influence of the disturbances in the measurements of the heating section central sensor 591 and heating section edge sensor 592.

It is also possible to arrange such a configuration that a memory (not illustrated) is used to store in advance the targeted temperature table (Table 1) storing the targeted temperature T for heating the auxiliary heating roller with respect to the temperature measurements by the heating section central sensor 591 and heating section edge sensor 592. Then the targeted temperature T is referenced from the temperature measurements of the heating section central sensor 591 and heating section edge sensor 592.

TABLE 1

| | | Heating section central sensor measurement (° C.) | | | | |
|---|---|---|---|---|---|---|
| | | | not less | not less | not less | |
| | | | than 150 | than 160 | than 170 | |
| | | less than | and less | and less | and less | not less |
| Target temperature T | | 150 | than 160 | than 170 | than 180 | than 180 |
| Heating section | less than 160 | 150 | 155 | 160 | 165 | 170 |
| edge sensor | not less than 160 and less | 155 | 160 | 165 | 170 | 175 |
| measurement | than 170 | | | | | |
| (° C.) | not less than 170 and less | 160 | 165 | 170 | 175 | 180 |
| | than 180 | | | | | |
| | not less than 180 and less | 165 | 170 | 175 | 180 | 185 |
| | than 190 | | | | | |
| | not less than 190 and less | 170 | 175 | 180 | 185 | 190 |
| | than 200 | | | | | |
| | not less than 200 and less | 175 | 180 | 185 | 190 | 195 |
| | than 210 | | | | | |
| | not less than 220 and less | 180 | 185 | 190 | 195 | 200 |
| | than 230 | | | | | |
| | not less than 230 | 185 | 190 | 195 | 200 | 205 |

For example, when the temperature measured by the heating section central sensor 591 is 165° C. and the temperature measured by the heating section edge sensor 592 is 195° C., then 180° C. is obtained by referring to the “not less than 160 and less than 170” item in the central section measured temperature column and the “not less than 190 and less than 200” item in the edge portion measured temperature column.

The heat generation of the auxiliary heater 551 is controlled based on the targeted temperature (e.g., 180° C.) referred to in the targeted temperature table.

In this case, there is no need of working out the temperature between the heating section central sensor 591 and a heating section edge sensor 592. The control of the controller C is simplified.

Referring to FIG. 2, the following describes the structure of separating the sheet P from the heating belt 51.

The toner image carried by the sheet P and molten by the heating belt 51 passes through the nip region N. The image attached to the heating belt 51 tends to be drawn inside the heating belt 51. This may cause a sheet conveyance error.

prevent this, an air blowing section 7 is provided to separate the sheet P from the heating belt 51by blowing air to the vicinity of the nip region N.

The air blowing section 7 includes a first air blowing section 71. for blowing air to the nip region. N regularly and a second air blowing section 72 for blowing air to the nip region N from the time immediately before the leading edge P1 of the sheet P enters the nip region N until the sheet the leading edge P1 passes through the nip region N.

The first air blowing section 71 has a normally operating fan 711 (e.g., sirocco fan) and a first nozzle 712 for blowing air to the nip region N by guiding the air of the fan 711 to the vicinity of the nip region N. The first air blowing section 71 reduces the temperature of the toner image having been heated by the heating belt 51 and having been fixed thereon, thereby separating the sheet P from the heating belt 51.

To reduce power consumption, the controller C can be made to allow the fan 711 to operate when the sheet P passes through the nip region N.

The second air blowing section 72 has a solenoid valve 721 for on-and-off operation of the air A1 fed from the compressor (not illustrated) and a second nozzle 722 for blowing air to the nip region N by guiding the air Al to the vicinity of the nip region N. The second air blowing section 72 has a function of separating the sheet P from the heating belt 51.

The opening of the first nozzle 712 has dimensions of approximately 300 mm×1 to 3 mm, and blows air at a speed of approximately 15 to 50 m/s.

The solenoid valve 721 is kept turned on by the controller C from the time immediately before the leading edge P1 of the sheet enters the nip region N until the sheet the leading edge P1 has passed through the nip region N.

As described above, when the air blowing section 7 is installed, the sheet P is separated in a non-contact state while the temperature of the toner image is reduced. Especially when much toner is to be used as in the case of color toner image, this arrangement prevents a contact scratch from being formed by the separation claw or the like on the toner image molten by fixing operation.

When a toner image is formed on the illustrated lower side (reverse side) of the sheet P as in the case of duplex printing, the toner image of the reverse side may be drawn into the nip roller 61 on the pressure side. To prevent this, a separation claw 73 as a separation measure is provided so that the sheet P is separated from the nip roller 61 on the pressure side by abutting on the nip roller 61 on the pressure side.

In conformity to various sizes of the sheets, a plurality of separation claws 73 are arranged in lines in an orthogonal direction X. Each of the separation claws 73 can be rocked about the spindle 731. The leading edge 7311 is biased toward the nip roller 61 on the pressure side by the elastic member 732 (e.g., tension spring), and the leading edge 7311 abuts on the surface of the nip roller 61 on the pressure side.

The separation claw 7311 is formed of polyimide resin and the surface is coated with PFA (tetrafluoroethylene-perfluoroalkyl vinyl ether copolymer) to improve the separability and release characteristics of the sheet P. The leading edge arc-shaped to a radius of approximately 0.05 mm.

As described above, when the nip roller 61 on the pressure side is provided with a separation claw 73 as a separation means for separating the sheet P, complete separation of the sheets P is ensured in the duplex printing mode as well.

In the monochromatic image forming apparatus, the amount of toner is smaller than that in the chromatic image forming apparatus. Thus, a separation claw 73 instead of the air blowing section 7 may be provided in the side of the heating belt 51.

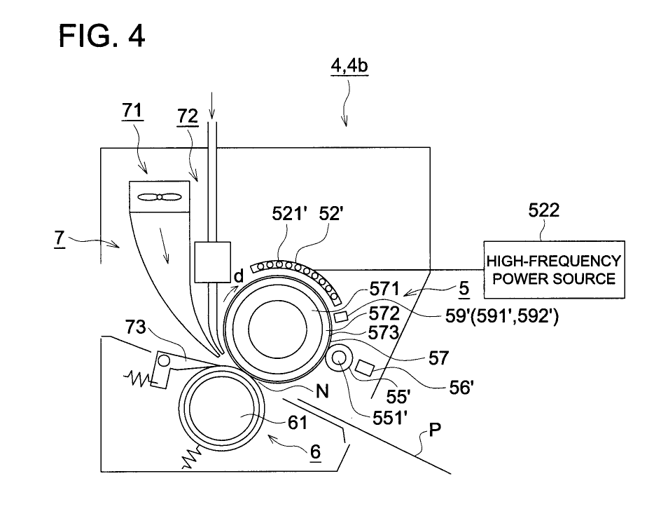

FIG. 4 is an explanatory diagram (side view) showing th.e second embodiment of a fixing device.

The fixing device 4b of the second embodiment has the same structure as that of the fixing device 4a of the first embodiment, except for the heating section 5 of the fixing device 4a of the first embodiment.

Accordingly, the following describes the heating roller 57, auxiliary heating roller 55′, and auxiliary roller temperature sensor 56′. Other structures are approximately the same as those of the first embodiment, and description of the details will be omitted.

Before starting the description of the fixing device 4b of the second embodiment, the following describes the concept thereof.

The IH heater 52′ causes the cored bar 571 of the heating roller 57 to generate heat. However, the mold release layer 573 and elastic layer 572 located outside the cored bar 571 are made of non-magnetic substances and cannot be made to generate heat.

In a high-speed machine wherein the mold release layer 573 and elastic layer 572 have lower heat transfer characteristics and there are a geater number of sheets to be output per hour in particular, before the portion of the heating roller 57 heated by the IH heater 52′ reaches the nip region N, only a part of the heat of the heat of the cored bar 571 having been heated reaches the mold release layer 573, with the result that the temperature of the heating roller 57 fails to reach the level wherein the toner image is completely molten.

Thus, in the second embodiment of the fixing device 4b, the mold release layer 573, elastic layer 572, and cored bar 571 are heated by the auxiliary heating roller 55′ so as to increase the temperature to the level wherein the toner image is completely molten in the nip region N.

The heating section 5 includes: a heating roller 57 for heating the sheet P; an IH heater 52′ for heating the heating roller 57 through magnetic induction; an auxiliary heating roller 55′ for heating the heating belt 51, auxiliary heating roller 55′ being in contact with the heating roller 57 and being located downstream of the IH heater 52 and upstream of the nip region N; an auxiliary roller temperature sensor 56′ for measuring the surface temperature of the auxiliary heating roller 55; and a heating roller temperature sensor 59′ for measuring the surface temperature of the heating roller 57.

The pressing section 6 has a nip roller 61 on the pressure side, arranged opposed to the heating roller 57, to form a nip region N.

The heating roller 57 has a diameter of 50 to 70 mm, and includes a cored bar 571 made up of a magnetic metal such as nickel and ion; an elastic layer 572 where the surface of the cored bar 571 is coated with the elastic body (e.g., a silicon rubber having a thickness of 2 to 15 mm and JIS-A hardness of 5 to 40); and a mold release layer 573 where the surface of the elastic layer 572 is coated with mold releasing agent (e.g., PFA, PTFE or mixed material thereof).

The heating roller 57 is driven by the driving section (not illustrated) in the direction of arrow d and the cored bar 571 made up of a magnetic metal is heated by the IH heater 52′. The toner image of the sheet P is directly heated and molten by the heating roller 57.

The IH heater 52′ has the same structure as that of the aforementioned IH heater 52, except that the IH heater 52 is arranged opposed to the heating roller 57 at a prescribed distance away Accordingly, the detailed description will be omitted.

The auxiliary heating roller 55′ has the same structure as that of the aforementioned auxiliary heating roller 55 except that the heating roller 57 heated by the IH heater 52′ is heated with the aid of the auxiliary heater 551′. Accordingly, the detailed description will be omitted.

The auxiliary roller temperature sensor 56′ measures the surface temperature of the auxiliary heating roller 55′, and has the same structure as that of the aforementioned auxiliary roller temperature sensor 56. Accordingly, the detailed description will be omitted.

The heating roller temperature sensor 59′ is arranged downstream of the IH heater 52′ and upstream of the nip region N opposed to the heating roller 57, and is used to measure the surface temperature of the heating roller 57.

Similarly to the aforementioned heating belt temperature sensor 59, a plurality of heating roller temperature sensors 59′ are provided on the central section and edge side of the heating roller 57.

The nip roller 61 on the pressure side is arranged opposed to the heating roller 57, and has the same structure as that of the aforementioned the nip roller 61 on the pressure side, except that sheet P is directly pressed against the heating roller 57. Accordingly, the detailed description will be omitted.

Based on the measurements of the heating roller temperature sensors 59′ arranged on the central section and edge side, the controller C obtains the targeted temperature T in the similar manner as the fixing device 4a of the aforementioned first embodiment.

Similarly to the case of the fixing device 4a of the first embodiment, the auxiliary heater 551′ is controlled in such a way that the temperature measurement of the auxiliary heating roller 55′ by the auxiliary roller temperature sensor 56′ will be equal to the targeted temperature T having been obtained.

The operation of the fixing device 4 (fixing device 4a and fixing device 4b) having been discussed so far is performed by the controller C of the image forming apparatus A.

The aforementioned embodiment provides a fixing device and an image forming apparatus including the same, wherein the fixing device is characterized by a high degree of fixing quality; capability of making the maximum use of the high-efficiency characteristics of an IH heater, and minimized power consumption.

What is claimed is:

1. A fixing device comprising:
(a) a heating section which heats a recording material;
(b) an induction heating heater which heats the heating section by an electromagnetic induction;
(c) a pressing section facing the heating section, which presses the recording material against the heating section;
(d) an auxiliary heating member in contact with heating section, provided downstream of the induction heating heater, and upstream of a nip area formed between heating section and the pressing section, which heats the heating section;
(e) an auxiliary heating member temperature sensor which measures a temperature of the auxiliary heating member; and
(f) a heating section temperature sensor provided downstream of the induction heating heater and upstream of the auxiliary heating member, which measures a temperature of the heating section.

2. The fixing device of claim 1, wherein the heating section temperature sensor comprises:
a heating section central sensor which measures a temperature of a central portion on the heating section in a direction perpendicular to a conveyance direction of the recording material; and
a heating section edge sensor which measures a temperature of on an edge side of the heating section at a position inside an edge portion of a passing area of the recording material having a maximum usable size, in the direction perpendicular to the conveyance direction.

3. The fixing device of claim 2,
wherein the heating section comprises a belt-shaped heating belt which heats the recording material; a backup roller which faces the induction heating heater through the heating belt, about which the heating belt is entrained on one side, and a nip roller on a heating side about which the heating belt is entrained on another side,
wherein the induction heating heater heats the heating belt,
wherein the auxiliary heating member heats the heating belt,
wherein the heating section central sensor and the heating section edge sensor measure a temperature of a surface of the heating belt, and
wherein the pressing roller comprises a nip roller on a pressing side Which presses the recording material against the nip roller on the heating side.

4. The fixing device of claim 2,
wherein the heating section comprises a heating roller which heats the recording material,
wherein the induction heating heater heats the heating roller,
wherein the auxiliary heating member heats the heating roller,
wherein the heating section central sensor and the heating section edge sensor measure a temperature of a surface of the heating roller, and
wherein the pressing roller comprises a nip roller on a pressing side which presses the recording material against the heating roller.

5. An image forming apparatus comprising:
an image forming section which forms a toner image;
the fixing device of claim 1, which fixes the toner image formed by the image forming section onto a recording material.

6. The image forming apparatus of claim 5, wherein the heating section temperature sensor comprises:
a heating section central sensor which measures a temperature of a central portion on the heating section in a direction perpendicular to a conveyance direction of the recording material; and
a heating section edge sensor which measures a temperature of on an edge side of the heating section at a position inside an edge portion of a passing area of the recording material having a maximum usable size, in the direction perpendicular to the conveyance direction, and the image forming apparatus further comprising:
a controller that establishes a targeted temperature to heat the heating roller, which is a value between a higher measured value and a lower measured value among values measured by the heating section central sensor and the heating section edge sensor, and controls an amount of heat generation of the auxiliary heating member so that the targeted temperature coincides with a value measured by the auxiliary heating temperature sensor.
